(19) United States
(12) Patent Application Publication
(10) Pub. No.: US 2017/0227933 A1
(43) Pub. Date: Aug. 10, 2017

(54) TIME-KEEPING DEVICES INCLUDING INDICATIONS BY MAGNETIC PARTICLES IN SUSPENSION IN LIQUID FILLED CHAMBERS

(71) Applicant: Preciflex SA, Neuchâtel (CH)

(72) Inventors: Lucien VOUILLAMOZ, Feusisberg (CH); Beyer MORTON, Roedkaersbro (DK); Gregory DOURDE, Neuchâtel (CH); Noelia BOCCHIO, Lausanne (CH)

(21) Appl. No.: 15/501,924

(22) PCT Filed: Aug. 6, 2015
(86) PCT No.: PCT/IB2015/001336

§ 371 Date: Feb. 6, 2017

Related U.S. Application Data
(60) Provisional application No. 62/033,686, filed on Aug. 6, 2014.

(51) Int. Cl. G04C 17/00

(52) U.S. Cl. CPC G04C 17/00

(57) ABSTRACT

A time-keeping device having a watch mechanism and method for use, the device having a watch dial that has at least one sealed chamber and/or capillary in a transparent substrate disposed on the side facing a user, and another side coupled to a micro-magnet drive system. The sealed chamber has at least a liquid with magnetic particles suspended therein. The micro-magnet driven system is driven, for example, by a clockwork mechanism under the watch dial.

### CROSS REFERENCE TO RELATED APPLICATIONS

This application claims priority to U.S. provisional application no. 62/033,686, of the same title and filed Aug. 06, 2014, the content of which is incorporated herein by reference thereto and relied upon to describe the invention claimed.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### TECHNICAL FIELD

The invention generally relates to time-keeping device mechanisms and indications, and methods used therein and thereby, and is used, by way of example, in fluidic time-keeping wrist watches and methods used therewith.

### BRIEF SUMMARY OF THE INVENTION

The present invention is directed to a device having an indication based on the use of ferrofluids. In one aspect, the invention provides a wearable device and/or portion thereof having a mechanical or electrical mechanism and method for use that includes and utilizes a variety of novel features.

In a variant, a watch dial includes one or more chambers, such as flat and expansive chambers, elongated, tubular chambers or channels, in a transparent substrate disposed on the viewing side of a user. Disposed on one (or more) sides of the chamber is a micro-magnet drive system. The driving side (typically distal to the viewing position of the user, is permeable to a magnetic field. The chamber includes liquids having magnetic particles—so called ferrofluids. The micro-magnet drive system may be driven by a clockwork mechanism under the watch dial.

In one aspect, the at least one sealed chamber includes a channel having at least one access node to enable filling thereof with at least the liquid and the magnetic particles.

In one variant, the chamber is a transparent capillary. In another variant, the chamber is a channel. The channel can be formed between two layers of the first and the second transparent substrate wherein the first and the second transparent substrate are assembled by, for example, gluing and/or fusion bonding. The channels, capillaries or chambers themselves can be themselves water and/or oil-repelling materials, or coated with materials with such properties. Moreover, the channels, capillaries and/ or substrates can be partially or completely opaque, luminescent—by means of i.e. paints or impregnation, tinting or coloring, or simply coated to different colors as for aesthetic purposes and/or readability.

In another variant, the chamber is a flat, expansive chamber.

In yet another aspect, the surface of the chamber is treated with particles responsive to the irradiation of tritium, and the particles emit radiation in the visible light spectrum.

The at least one sealed chamber, channel or capillary includes at least one liquid including magnetic particles.

In yet another aspect, the invention provides a watch dial in which the at least one liquid comprises a bubble of radioactive tritium, which may or may not be used to indicate time or other quantities over an index.

In further variants, the invention provides a watch dial in which the liquid includes at least two immiscible liquids.

The magnetic particles used in the invention include metal oxides, pure metals or alloys; the metal oxide is selected from the group consisting of an oxide of iron, nickel, cobalt or other material with similar magnetic properties.

In yet another aspect, the watch dial further includes a micro-magnet. The watch dial is constructed in a manner so as to indicate and/or dispose a concentration of magnetic particles in a suspension in the liquid at a specific location of a capillary, channel and/or a chamber above the micro-magnet.

The time piece and/or portion of a time piece is constructed such that an index is engraved and/or disposed adjacent or above the watch dial, optionally on a side facing a user's viewpoint and includes at least one watch indication.

In another embodiment, a chamber is closed, and includes a sufficient thickness and a width such that a concentration/conglomeration of magnetic particles and the chamber form a piston assembly system.

In another variant, the magnetic particles are arranged so that they create a micro-induced magnet and are in a channel, in a concentration sufficient to form a piston which moves an entire column of the liquid in a channel.

In other variants, an indication for a watch or portion thereof is provided by the invention. The indication is produced by a colored liquid segment pushed by the piston assembly, and the colored liquid segment moves adjacent the watch indication.

The watch dial also includes an additional watch mechanism, the watch dial includes indicators coupled to an indication of time or other information. The indication is selected from the group consisting of hours, minutes, seconds and other useful information presented in a watch.

In yet a further embodiment, the watch dial includes an additional mechanism, and the additional mechanism is selected from the group consisting of a mechanical mechanism driven by an escapement or any other regulation source, such as, for example, a quartz mechanism. In a particular embodiment, the regulation may be provided by connection to a network such as the Internet, or the Cloud™.

In yet another variant, the watch dial further includes a shielding assembly providing shielding from a magnetic field or isolation of the magnetic field generated by the mechanism of the invention.

Other features and advantages of the present invention will become apparent from the following detailed description of the invention made with reference to the accompanying drawings. These and other aspects of the invention will be apparent from and elucidated with reference to the embodiments and drawings described hereinafter.

### BRIEF DESCRIPTION OF THE DRAWINGS

The subject matter of the invention will be explained in more detail in the following text with reference to exemplary embodiments which are illustrated in the attached drawings.

FIG. 1A is a top schematic view of a mechanism, assembly, and method(s) of the present invention.

FIG. 1B is a side cross-sectional cut away view along line A-A of FIG. 1A.

FIG. 1C is a side view of the gas-liquid interface in the interior of the mechanism of FIG. 1A.

FIG. 2 is a schematic side cross-sectional view of a sub-assembly of one variant of the system of the invention.

FIG. 3 is a variant of an indication of the invention.

FIG. 4 is yet a further variant of an indication of the invention.

FIG. 5 is another variant of an indication according to an embodiment of the invention.

FIG. 6 is a variant of an indication of the invention.

FIGS. 7A to 7E show yet another embodiment of the invention.

Those skilled in the art will appreciate that elements in the figures are illustrated for simplicity and clarity and have not necessarily been drawn to scale. For example, dimensions may be exaggerated relative to other elements to help improve understanding of the invention and its embodiments. Furthermore, when the terms “first”, “second”, and the like are used herein, their use is intended for distinguishing between similar elements and not necessarily for describing a sequential or chronological order. Moreover, relative terms like “front”, “back”, “top” and “bottom”, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF EXEMPLARY EMBODIMENT(S)

The following description is not intended to limit the scope of the invention in any way as they are exemplary in nature, serving to describe the best mode of the invention known the inventors as of the filing date hereof. Consequently, changes may be made in the arrangement and/or function of asiny of the elements described in the exemplary embodiments disclosed herein without departing from the spirit and scope of the invention.

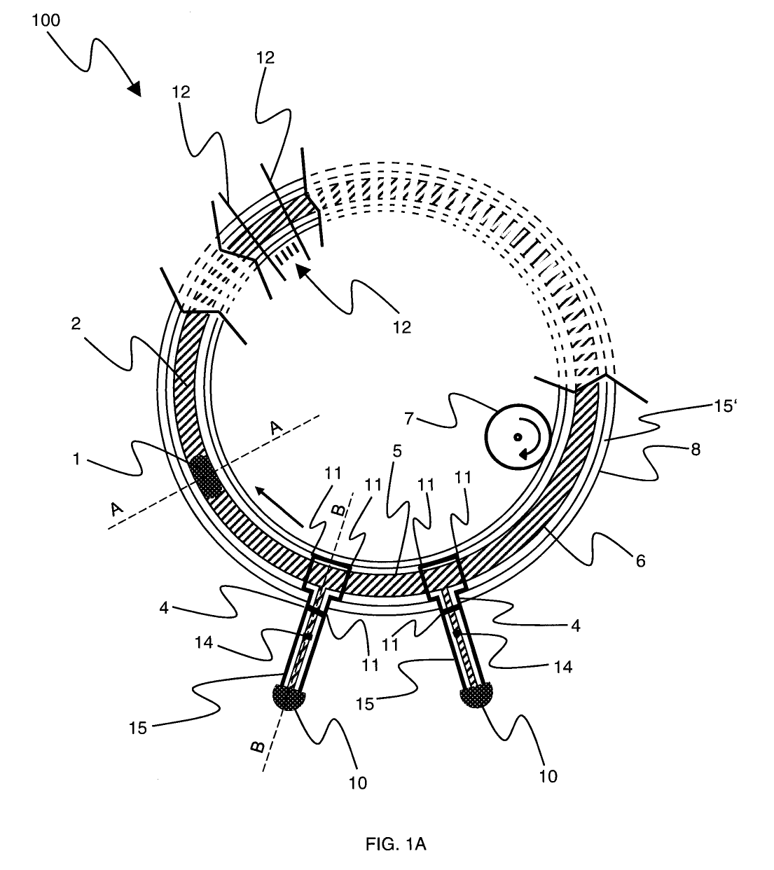

Referring now to FIGS. 1A-1C, an overall view of a system 100 of the present invention is shown via an overall top view and various cross-sections of the system 100. The system 100 functions to, for example, indicate hours, minutes or seconds on a circular fashion bracelet watch in a closed circuit. Other indications, such as blood pressure or body temperature may be provided.

In one embodiment, the system 100 includes a circular capillary 15′ formed of borosilicate glass, from one or more segments 5, 6. In the embodiment of FIG. 1A-1C, the capillary is formed from at least two segments 5, 6; two T-fittings, 4; (optionally and alternatively), and two other transparent segments 15 are also provided, of stainless steel or borosilicate glass. One or more micro-magnets 9 are provided, for example, made of neodymium. A drive disk 8 on which is mounted one or more magnets 8, disposed a circumferential distance from one another, all adjacent the capillary, for movement below and along the capillary. For example, a disk drive 7 engages a rack in the disk 8 to effect movement of the micromagnets below the capillary. One or more segments of particles with a magnetic behavior, such as magnetic particles (either ferro-, ferri-, or para-magnetic, particularly magnetite, ferrites, nickel oxide or cobalt oxide ; iron, nickel or cobalt in metallic form, or rare earth components such as Gadolinium, composites thereof, and alloys thereof, of each metal or combination thereof). The magnetic particles are preferably of a dark color 1 and are capable of being treated superficially in different manners according to a desired purpose.

An increase in concentration of particles in a desired area (e.g. to form the image of a number or a logo or other image) is achieved by one or more of the magnet(s), and it is such that the segment comprises either a visible area such as an indicator, which moves in a liquid environment, or as a piston (see various embodiments described herein.) A liquid 2 in which the segment 1 moves or which is driven by the latter is also provided.

Expansion of gas 3 to liquid 2 form is indicated in the chamber at FIG. 1D. Two menisci between the gas 3 and the liquid 2 are formed as indicated in FIG. 1C.

Glues or other elements for the connection between the fittings and T segments of capillaries are also indicated as element 11. Plugs 10 including glues or other plugging members are provided at the ends of the capillary 15 (or, optionally connectors, if the latter are not provided with capillaries) are also included in system 100. Surface treatment A 13 may be applied inside the capillary segments and T-connections. It may be of various types, depending on the embodiment.

As shown in FIG. 1B, a surface treatment 13 can be applied within the segments of the interior of capillaries and fittings T. It may be of various types, according to the respective figure. Both circular capillary access (for example) nodes are included which allow the filling of the capillary by ensuring that the segments are sufficiently accessible to prevent liquid that reaches the gas bubble remains in the main channel before access closure. The purpose of this embodiment is to (1) have a bubble of gas in the zone 3, to compensate for variations in volume of the system due to thermal expansion or retraction and (2) insure that the bubble stays in the zone 3, no matter what operational mode the system is in. The bubble must be prevented from migrating into the channel.

Segments remain operational and provide for intentionally trapping gas by the plugs 10, the allow for thermal expansion and contraction of the latter within the limits corresponding to the requirements of a luxury watch (0 to 50° C., see −20 to +70° C.). Materials and adhesives or sealing methods using plugs 10 and capillaries 15, 15′ are chosen according to their resistance to stress and temperature of the substrates they are sealing and/or connecting (e.g. borosilicate, metal, ceramics, liquid).

One specific surface treatment 13 may be applied inside the capillary segments and within T-connections, depending on the desired embodiment. Fittings permit the transmission of the magnetic field generated by the magnet 9, so as not to disturb the driving segment.

In this embodiment, the magnet 9 is driven by the disk 8, which is itself driven by the drive wheel system 7. It is advantageously located under the capillary so as to be hidden from the sight of the observer. Dial lettering and the magnetic field interaction with elements of the system can also be used between the magnet and the capillary, so as to completely hide the drive system from the user side of the back channel. In any case, it is useful to create a contrast. As illustrated by wheel sub-system 7, a complete rotation of the magnet may be invoked within 12 hours, 1 hour or 1 minute, and/or any other desired time scale. The cooperating sub-system with system 100 can be a mechanical sub-system, an electrical type (quartz) subsystem, or via network connection, to the Cloud™ for example. The system 100 is optionally provided with an index 12 for reading the specified value.

In its most basic form, the invention is a device for moving magnetic particulate. In this embodiment, the device includes either an expansive chamber with a low ceiling, a tube or a channel, a magnetic particulate, and a driving means. The chamber, if a narrow tube or channel, may have capillary characteristics, and is filled at least in part with a liquid. The magnetic particulate is suspended in the liquid. The particulate may be, for example, a ferro-magnetic, ferri-magnetic, para-magnetic, magnetite, ferrites, nickel oxide, cobalt oxide, iron, nickel, metallic cobalt, rare earth magnets components, Gadolinium, or Neodymium, to provide an exemplary listing. Other materials may also be suitable. The driving means is adapted to form and drive the magnetic particulate into at least one visible clump of a desired form, and optionally, to drive the clump of magnetic particles.

The clump may serve as an indicator along an index. Optionally, the clump is of sufficient density to act as a piston which drives the liquid in the channel or tube. Alternatively, a meniscus of the driven liquid serves as an indicator along an index.

As already described above in relation to the drawings figures, the invention can be applied to a timekeeping device which has a time indication. The time indication further has a sealed, transparent tube or channel positioned adjacent an index and visible to a user of the timekeeping device. The user can then see within the channels or tube. The formed magnetic clump is visible to the user as well so that when juxtaposed to an index, a time can be read. The timekeeping device has a regulation device and a micro-magnet drive system having magnets coupled thereto generating a magnetic field. The micro-magnets drive system is arranged such that the clump of magnetic particulate interacts with the magnetic field so as to be driven by the drive means according to inputs from the regulation device.

The regulation device may be selected from a number of regulation devices such as a clockwork mechanism, particularly a mechanical clockwork mechanism, a quartz clockwork mechanism, or a nuclear clockwork mechanism, and a processor in a network to which the device connects and communicates, such as a connection to the Cloud™.

### Example 1

The segment 1 is driven by the magnetic field of the magnet 9. The drive moves the suspended magnetic particles segment without necessarily moving the liquid in which the particles are suspended. In any case, an optional surface treatment may be added to the capillary or channel surface to attract the liquid and repel the magnetic particles in order to allow liquid to pass between the magnetic particles and the capillary or channel. This can reduce resistance as well as reduce any movement in the liquid that might be caused by the moving of the clump of magnetic particles. To increase the contrast, one can choose a liquid with the same refractive index as the substrate.

### Example 2

In this embodiment, a segment, preferably a short segment, of colored liquid may be encapsulated between two dense clumps of magnetic particles and may be driven by these clumps. The clumps are themselves driven by, for example, two magnets 9, located below the segments of magnetic particulate. The magnetic particulate, when formed in clumps of sufficient density, may be designed to function as pistons. In this case, the surface treatment described herein, and connections will be made to repel the two kinds of liquids and the ferro-fluid. It will also provide a driver to push any colored liquid.

### Example 3

A segment of colored liquid is placed before or after the segment 1 and is driven by this segment, itself being driven by a magnet 9, which functions as a piston. The segment of colored liquid is immiscible with a second liquid segment (whether fully transparent or not). In this case, the surface treatment of elements of system 100 and connections will be made to repel the two kinds of liquids and the ferromagnetic particles. The colored liquid is separated by a transparent liquid meniscus.

### Example 4

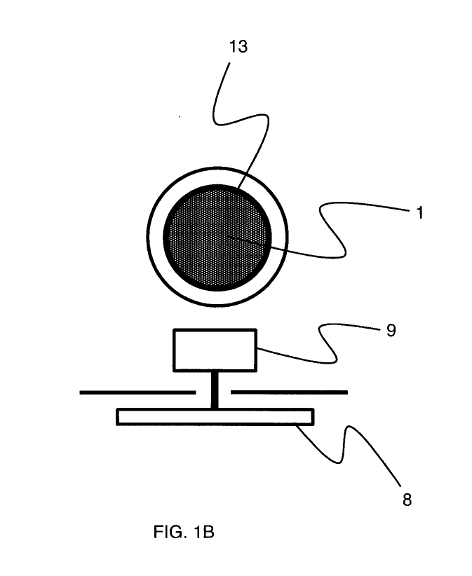

This Example is analogous to Examples 2 and 3 described above. In this embodiment, a colored liquid segment is bounded by two pistons, the colored liquid segment and the pistons being integrated into a third liquid, which is immiscible with the colored liquid and the pistons. In this example, the substrate or a surface treatment inside of the channel, attracts the third liquid. Referring again to FIG. 2 of US provisional application U.S. 61/974,448, the content of which is incorporated by reference and relied upon, this embodiment uses a chamber of a variable form between two substrates which are fusion bonded and filled with liquid as described in. A filling system with an entry and an exit which is similar to embodiment 1 is used. For absorbing or compensating for contractions and expansions of the liquid, one uses either the system shown in embodiment 1, or an embodiment shown in the mentioned FIG. 2. The magnetic particles will move inside of a fluid microfilm of the third liquid attracted by the substrate or the surface treatment. This same principle with a single piston comprising magnetic particles is described in Example 3.

### Example 5

Referring again to the US provisional application cited above (particularly FIG. 2 thereof), in this example, the capillary is replaced by a channel between two transparent substrates that are: (1) fusion bonded, (2) glued (e.g. along glue lines), (3) weld bonded substrates, and/or (4) press fit together. The thickness of the channel is preferably in the range of a few hundredths to a few tenths of a millimeter and its width is preferably in the range of a few tenths to a few mm to allow for the creation of menisci, particularly as shown in the referenced figure. The surface of the channel is transparent. T-fittings are incorporated in the design of the channels (drawing steps). This feature also optionally applies to Examples 1-4.

### Example 6

This embodiment is based on Example 5 (channels instead of capillaries are provided) as conduits, and the embodiments 2-5 have a primary purpose of driving the magnetic particulate. In this embodiment, the surface of the channel is of a frosted glass type. The colored liquid is replaced by a liquid having the same refractive index as the substrate. This will make it transparent and the segment enables the reading of information behind the segment in question.

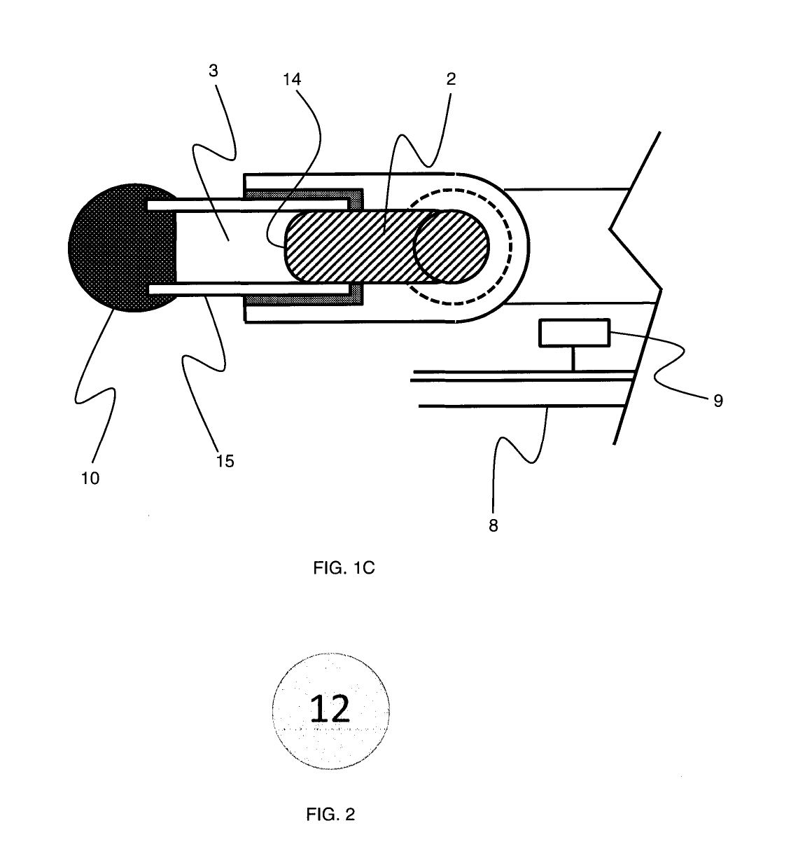

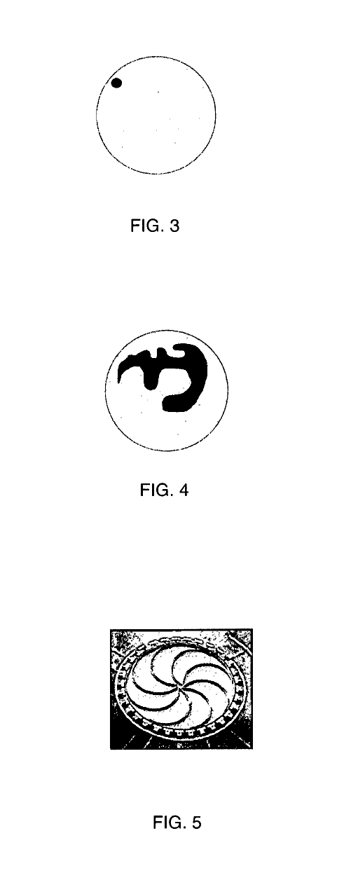

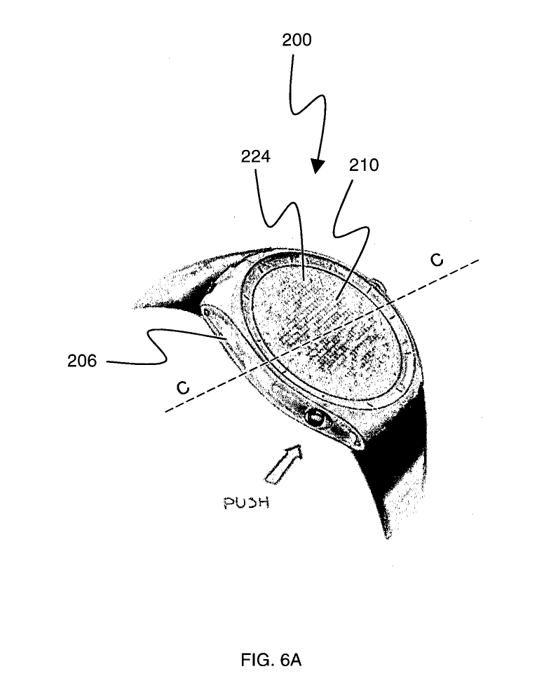

Referring now to FIGS. 2-5, ferromagnetic suspended particles accumulate on the magnetic field lines drawn by the micro-magnet movement located beneath the substrate. These accumulations may form figures that appear and disappear, as shown in FIG. 2 or art forms shown in FIG. 4, or shapes that move or “flow” such as shown in FIG. 3. In this case, if an index exists on the substrate (not shown), it can indicate a variable, such as time. To conceal the magnets, an opaque layer is between the magnet system and the substrates is provided. The animation of the magnets can be made by mechanical or quartz watch movement, which sets in motion the magnets (see FIG. 5, as an exemplary representation).

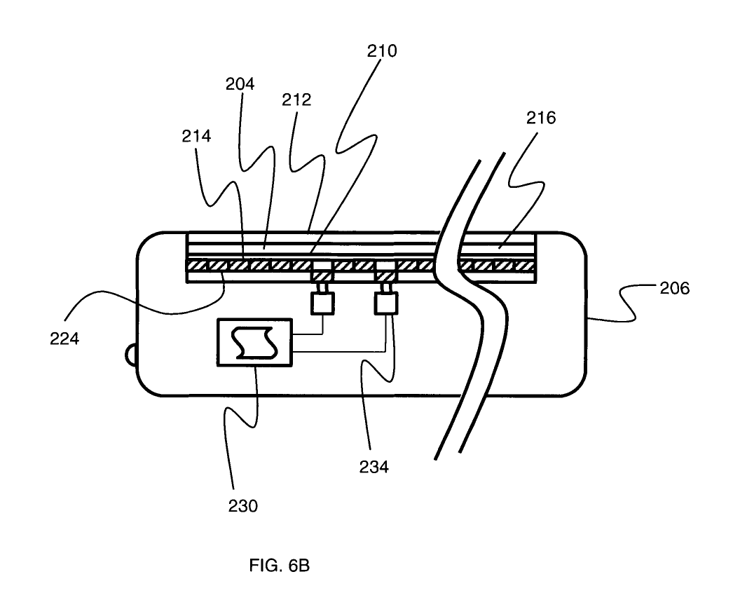

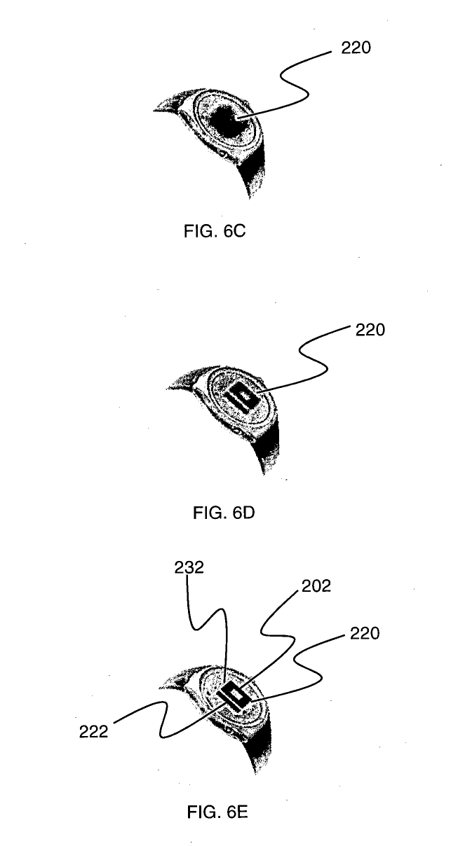

Referring now to FIGS. 6A to 6E, an alternate embodiment of an indicating device 200 is provided. In this embodiment, the magnetic particulate 202 is contained in a sealed substantially flat, expansive chamber 204 (between the housing 206, the face 210, and the crystal 212, which is transparent), the crystal 212 providing a low, transparent ceiling. The chamber 204 is filed with a liquid 216 having a magnetic particulate 202 suspended in the liquid 216, and has a floor 210 made up of a matrix of magnetic field inducing panels 214. The indicating device 200 indicates for example, time, or an image such as the logo of the manufacturer, by forming at least clump 220 of the magnetic particulate in the expansive chamber 204 by inducing, positioning or selectively shielding magnetic fields in select panels so as to form a desired clump. In one variant, the clump is an at least one time-indicating numeral 222.

In this chamber 204, an electromagnet 214 or group of electromagnets associated with a matrix 224 are controlled to activate and deactivate electromagnetic panels 214.

When a matrix panel control system 230 creates the appearance of an image 232 (e.g., a number on request, in the case of a watch), it does so by activating the electromagnet panels 214 in such a way that each panel collects the magnetic particles 202 suspended in the liquid 216 starting from the end of the image to be created and the center, collecting magnetic particles to create the desired image. When the activation of the electromagnet panels 214 is deactivated, the particles 202 are again dispersed into the liquid 216, and no image is visible.

The controller 230 can also control the appearance of the images generated, so as to, for example, morph one image to another image, moving or giving an impression of movement in the liquid 216.

It should be noted that all versions of the present invention may be implemented using a purely mechanical system, in other words, without electromagnets and without requiring a battery. Permanent magnets may be substituted for electromagnet panels 214 in which the “on” or “off” functionality is achieved using shielding and or mechanical removal or repositioning (lowering away from the watch face) of the permanent magnets, for example, by actuators 234, controlled by the control system 230. The actuators 234 can be purely mechanical cam mechanisms driven by a purely mechanical movement.

In an advantage, the invention provides a way of creating a piston for moving fluids or indicating a measure.

In another advantage, the invention creates a pleasing even dynamically functioning watch face without the expense of other systems.

As will be appreciated by skilled artisans, the present invention may be embodied as a system, a device, or a method. Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of or “consisting essentially of is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention. The patents and articles mentioned above are hereby incorporated by reference herein, unless otherwise noted, to the extent that the same are not inconsistent with this disclosure.

Other characteristics and modes of execution of the invention are described in the appended claims. Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-a-vis the public or third parties, no express or implied license is granted to prepare derivative works based on this patent specification.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A device for moving magnetic particulate, the device including:
a. at least one chamber filled at least in part with a liquid;
b. a magnetic particulate suspended in the liquid, the particulate selected from the group of magnetic particulate consisting of ferro-magnetic, ferri-magnetic, para-magnetic, magnetite, ferrites, nickel oxide, cobalt oxide, iron, nickel, metallic cobalt, rare earth magnets components, Gadolinium, and Neodymium ; and
c. driving means adapted to form the magnetic particulate into at least one clump of a desired form and, optionally, drive the clump of magnetic particulate, wherein the chamber is a narrow, closed channel or capillary and the clump of magnetic particles moves along the channel or capillary.

2. The device of claim 1, wherein the clump serves as an indicator along an index.

3. The device of claim 1, wherein the clump moves along the capillary without substantially moving the liquid.

4. The device of claim 1, wherein the clump is of sufficient density to act as a piston which drives the liquid in the channel or tube.

5. The device of claim 4, wherein the clump drives a bubble, such as a tritium bubble.

6. The device of claim 4, wherein a meniscus of the driven liquid serves as an indicator along an index.

7. The device of claim 1, being a timekeeping device, the timekeeping device having a time indication, the time indication further comprising:
a. the at least one channel or tube being a sealed tube or channel formed of a transparent substrate, the transparent substrate being positioned adjacent an index and visible to a user of the timekeeping device such that a user of the timekeeping device can see within the channels or tube such that the formed magnetic clump is visible to the user;
b. a regulation device;
c. a micro-magnet drive system having magnets coupled thereto generating a magnetic field, arranged such that the clump of magnetic particulate interacts with the magnetic field so as to be driven by the drive means according to inputs from the regulation device.

8. The device of claim 7, wherein the regulation device is selected from the group of regulation device consisting of a clockwork mechanism, a mechanical clockwork mechanism, a quartz clockwork mechanism, a nuclear clockwork mechanism, and a processor in a network to which the device connects and communicates.

9. An indicating device having a magnetic particulate contained in a sealed substantially flat, expansive chamber with a low, transparent ceiling, the chamber having a floor made up of a matrix of magnetic field inducing panels, the indicating device indicating a quantity by forming at least one indication clump of the magnetic particulate in the expansive chamber by controlled induction of magnetic fields in select panels so as to form the indication clump.

10. The device of claim 9, wherein the controlled induction is performed by a processor running an application specific algorithm.

11. The device of claim 9, wherein the at least one indication clump is an at least one time-indicating numeral.

12. The device of claim 9, wherein the indication clump indicates an image such as a logo.

13. A device for moving magnetic particulate, the device including:
a. at least one chamber filled at least in part with a liquid;
b. a magnetic particulate suspended in the liquid, the particulate selected from the group of magnetic particulate consisting of ferro-magnetic, ferri-magnetic, para-magnetic, magnetite, ferrites, nickel oxide, cobalt oxide, iron, nickel, metallic cobalt, rare earth magnets components, Gadolinium, and Neodymium; and
c. driving means adapted to form the magnetic particulate into at least one clump of a desired form and, optionally, drive the clump of magnetic particulate.
